(19) United States
(12) Patent Application Publication
(10) Pub. No.: US 2026/0296592 A1
(43) Pub. Date: Oct. 1, 2026

(54) BIKE TRAILER AND BIKE TENT

(71) Applicant: Jin Gyeong YUN, Seoul (KR)

(72) Inventor: Jin Gyeong YUN, Seoul (KR)

(21) Appl. No.: 19/478,005

(22) PCT Filed: Apr. 4, 2024
(86) PCT No.: PCT/KR2024/095675

§ 371 Date: Oct. 23, 2025

(30) Foreign Application Priority Data
Apr. 26, 2023 (KR) 10-2023-0054754
Mar. 29, 2024 (KR) 10-2024-0043200

(51) Int. Cl. B62K 27/00; B62K 27/02; B62K 27/12

(52) U.S. Cl. CPC B62K 27/003; B62K 27/02; B62K 27/12

(57) ABSTRACT

Provided may be a bike trailer (3) in which a leisure item can be loaded and which can be moved by a transportation means. The bike trailer 3 may comprise: a trailer body (200) including a support frame (210) for supporting the leisure item, wheel coupling parts (220) provided on both left and right sides of the support frame, respectively, and a transportation coupling part (230) formed on the support frame so that the transportation coupling part can be coupled to the rear side of the transportation means by a connecting member (300); and a wheel assembly (400) including a journal (410) having a bearing, a wheel (420) supported and rotated by the journal (410) and having a wheel hub (421) accommodating the journal (410), a tire (430) coupled to the wheel (420), and a wheel coupling boss protruding in the left and right directions from the journal (410) to be detachably coupled to the wheel coupling parts (220).

### TECHNICAL FIELD

The present invention relates to a bike trailer and a bike tent having the same, and more particularly, to a bike trailer and a bike tent that can be towed by a transportation means such as a bicycle or motorcycle.

### BACKGROUND ART

Camping is pitching a tent and staying overnight in a place like a mountain, field, or beach. When camping, the tent may be loaded and transported in a car, or a camping trailer may be connected to the car to be moved, or a camper van of which a structure itself is optimized for camping is used to enjoy camping.

As the number of people enjoying bicycle travel has increased due to the recent expansion of bicycle roads, the number of people enjoying bicycle camping has also been steadily increasing. People enjoy bicycle camping in which they load tents onto their bicycle racks, move them to camping sites, and then set up camp.

However, in conventional bicycle camping, it is difficult to load a large amount of luggage due to the characteristics of the bicycle rack. Furthermore, there were cases in which the bicycle was difficult to control due to an excessive weight of a load loaded on the rack, causing loss of balance or collision with surrounding obstacles, resulting in safety accidents. When a regular tent is used for bike camping, it takes a lot of time to set up and arrange the tent.

### DETAILED DESCRIPTION OF INVENTION

### Technical Problem

The present invention is to solve the problems in the above-described conventional technology, and to provide a bike trailer having a detachable wheel assembly so that the bike trailer can be pulled by connecting it to a transportation means such as a bicycle or a cart while a tent is loaded therein.

Additionally, a bike tent is provided that has a detachable wheel assembly on a tent frame so that the tent itself can be pulled around by connecting it to a transportation means such as a bicycle, motorcycle, or cart.

The technical problems to be solved by the present invention are not limited to the technical problems described above, and other technical problems not described can be clearly understood by a person having ordinary skill in the technical field to which the present invention belongs from the description below.

### Technical Solution

According to the present disclosure, a bike trailer 3 can be provided as a method for solving the above-described fundamental problem.

The bike trailer (3) can load leisure items and be moved by a transportation means. The bike trailer (3) may include a trailer body (200) including a support frame (210) which supports the leisure item, a wheel coupling part (220) provided on each of left and right sides of the support frame, and a transportation coupling part (230) formed on the support frame to be coupled to a rear side of the transportation means by a connecting member (300), and a wheel assembly (400) including a journal (410) having a bearing, a wheel (420) which is supported by the journal (410) to rotate and has a wheel hub (421) that accommodates the journal (410), a tire (430) coupled to the wheel (420), and a wheel coupling boss (440) which protrudes in left and right directions from the journal (410) and is detachably coupled to the wheel coupling part (220).

The wheel coupling part (220) may include a pipe part (221) coupled to the support frame (210) to extend in the left and right directions, a hooking member (222) which penetrates the pipe part (221), and a spring (224) which controls the hooking member (222) to switch between a first position and a second position by an external force, the first position is a position at which the wheel coupling boss (440) and the pipe part (221) are coupled, and the second position is a position at which the wheel coupling boss (440) and the pipe part (221) are decoupled.

In the pipe part (221), a first hole (2211) and a second hole (2212) facing the first hole may be formed in front and rear directions, and a third hole (2213) may be formed next to the second hole in the left and right directions, the hooking member (222) may be a U-shaped hooking member (222) with one end short and include a straight portion (2221) inserted to penetrate the first hole and the second hole, and a head portion (2222) that is bent in the left and right directions from one end of the straight portion protruding through the second hole, then bent again in the front and rear directions and inserted into the third hole, the wheel coupling part (220) may further include a nut (223) fastened to a screw thread formed on the other end of the straight portion protruding through the first hole; and a washer (225) interposed between the spring (224) and the nut (223), and the spring (224) may be provided between the nut and the first hole to be penetrated by the straight portion.

In a side surface of the wheel coupling boss (440), a hooking groove (441) that extends in a circumferential direction may be formed with a depth designed so that an end portion of the head portion of the hooking member is inserted when the wheel coupling boss (440) is inserted into the pipe part, and the end portion of the wheel coupling boss (440) may be tapered so that a diameter thereof is reduced.

In a state in which an external force is applied to the nut and the coil spring is compressed so that the end portion of the head portion of the hooking member partially protrudes through the second hole, the wheel coupling boss (440) may be inserted into the pipe part, then the external force may be removed, and the coil spring may be restored, so that the end portion of the head portion of the hooking member is inserted into the hooking groove (441), whereby the wheel may be mounted on the trailer body, and as the coil spring is compressed by applying the external force to the nut, the end portion of the head portion of the hooking member may be detached from the hooking groove (441), and the wheel coupling boss (440) may be pulled out of the pipe part, whereby the wheel assembly may be detached from the trailer body.

A connecting member (300) that is coupled to the transportation coupling part (230) of the trailer body (200) may be further included, and the connecting member (300) may be detachably coupled to a handle member (500) for a user to hold and move the bike trailer or a coupling member (600) for coupling to the rear side of the transportation means.

The connecting member (300) may include a first connecting part (310) coupled to one end portion of the trailer body, a second connecting part (320) having a pipe shape and coupled to the handle member (500) or the coupling member (600), and a spring part (330) coupled to one end of the first connecting part (310) and one end of the second connecting part (320), and elastically coupling the first connecting part (310) and the second connecting part (320) between the first connecting part (310) and the second connecting part (320), and the first connecting part (310) of the connecting member (300) may have a bent portion between both ends.

The handle member (500) may include a base portion (510) which is detachably coupled to the second connecting part (320) of the connecting member (300) and has one or more through holes (515), and a handle portion (520) which extends from the base portion (510) and is configured in a shape that allows the user to grasp.

The coupling member (600) may include an insertion part (610) having a cylindrical shape inserted into a pipe shape of the second connecting part (320) of the connecting member (300) and having a through hole (615) through which a fixing pin (351) passes, an intermediate part (620) which extends from one end of the insertion part (610) and having a dimension larger than an inner diameter of a pipe shape of the first connecting part (310) of the connecting member (300), and a coupling part (630) having a first portion coupled to one end of the intermediate part (620) and a second portion having a fixing hole (635).

A trailer cover (700) may be further included, the trailer cover (700) may include a main cover (710) which covers the trailer body (200), a side cover (720) which extends upward from the main cover (710) and forms a storage space, and an upper cover (730) which covers an upper portion of the side cover (720) and the storage space formed by the side cover (720) and seals the storage space, the side cover (720) may include first zipper teeth (721) formed at a coupling portion of the side cover (720) and the main cover (710), and second zipper teeth (722) formed at a coupling portion of the side cover (720) and the upper cover (730) and configured to be fastened to the first zipper teeth (721), and the main cover (710) may include a first fastening member (711a) formed at one end portion of the main cover (710), a second fastening member (711b) formed at the other end portion of the main cover (710) and configured to be coupled to or uncoupled from the first fastening member, an adjustment strap (712) formed at an edge of a lower end portion of the main cover (710) and configured to adjust a size of an opening at the lower end portion of the main cover (710), and an identification part (713) formed at a portion of the main cover (710) on a side opposite to the transportation means and configured to identify presence of the transportation means by another transportation means following the transportation means.

According to the present disclosure, a bike tent (1000) may be provided as another method for solving the above-described fundamental problem. The bike tent (1000) includes a foldable tent (1100) which is configured to be switched between a folding mode in which it is folded and a camping mode in which it is unfolded and includes a foldable tent frame (1110) and a tent cloth (1120) coupled to at least a part of the tent frame (1110) and supported by the tent frame (1110), a connecting member (300) which connects a transportation means and the tent frame (1110), a wheel mounting unit (1200) coupled to a lower side of the tent frame (1110), and a wheel assembly (400) detachably coupled to the wheel mounting unit (1200).

The wheel assembly (400) may include a journal (410) having a bearing, a wheel which has a wheel hub that accommodates the journal (410), and is supported by the journal (410) to rotate, a tire (430) coupled to the wheel, and a wheel coupling boss (440) which protrudes in left and right directions from the journal (410) and is detachably coupled to the wheel mounting unit (1200), the wheel assembly (400) may be coupled to each of left and right sides of the wheel mounting unit (1200), the tent frame (1110) may include a main frame (1111) connected to a bottom of the tent cloth (1120), a pair of upper frames (1112) which is rotatably installed on the main frame (1111), unfolds the tent cloth upward and supports it, a pair of lower frames (1113) rotatably installed on the main frame (1111) and unfolded to support the main frame, and a pair of lower frames (1113) rotatably installed on the main frame (1111) and unfolded to support the main frame, and a slot frame (1114) which has a cross-sectional shape that accommodates at least a part of the wheel mounting unit (1200) and is coupled to each of the lower frames (1113) to extend in the left and right directions, and to which the wheel mounting unit (1200) is detachably coupled.

The wheel mounting unit (1200) may include a shaft bar (1210) which is inserted into a pair of slot frames (1114) in the folding mode and extends in the left and right directions, a fastening member (1220) which penetrates and connects the shaft bar (1210) and the slot frames (1114) in front and rear directions, and a wheel coupling part (220) coupled to left and right edges of the shaft bar (1210) and to which the wheel coupling boss (440) of the wheel assembly is detachably coupled.

The wheel coupling part (220) may include a pipe part (221) which is coupled to both side edges of the shaft bar (1210) to extend in the left and right direction, and in which a first hole and a second hole facing the first hole are formed in the front and rear directions, and a third hole is formed next to the second hole in the left and right directions, a U-shaped hooking member (222) having one short end, and including a straight portion inserted to penetrate the first hole and the second hole, and a head portion that is bent in the left and right directions from one end of the straight portion protruding through the second hole, then bent again in front and rear directions and inserted into the third hole, a nut (223) coupled to a screw thread formed on the other end of the straight portion protruding through the first hole, a coil spring (224) provided between the nut and the first hole to be penetrated by the straight portion, and a washer (225) interposed between the coil spring and the nut.

A first sheet (1125) provided in a shape corresponding to an entrance of the tent cloth (1120) for the user to enter and exit to cover the entrance, and a second sheet (1126) provided in a shape corresponding to the first sheet and connected to one end portion of the first sheet (1125) may be further included, and the first sheet (1125) and the second sheet (1126) may be coupled or decoupled by a first coupling member (1125a) formed at an edge of the first sheet (1125) and a second coupling member (1126b) formed at an edge of the second sheet (1126).

The first sheet (1125) and the tent cloth (1120) may be coupled or decoupled by a third coupling member (1125b) formed further outward than the first coupling member (1125a) of the first sheet (1125) and a fourth coupling member formed at a corresponding position of the tent cloth (1120), the first sheet (1125) may include an extension sheet (1125c) that extends further outward than the third coupling member (1125b) and prevents liquid from entering from outside the tent through the third coupling member (1125b), and a fixing hole (1126b) which fixes a pole may be formed at one end portion of the second sheet (1126).

### Advantageous Effects

According to an embodiment of the present invention, it is possible to provide a bike trailer having a detachable wheel assembly so that the bike trailer can be connected to a transportation means such as a bicycle or a cart to be pulled while a tent is loaded therein.

According to an embodiment of the present invention, the wheel assembly (400) can be easily attached to and detached from the trailer body (200), making it convenient to use. After the wheel assembly (400) is mounted on the bike trailer (3), the bike trailer (3) can be moved to a camping site by connecting it to a transportation means such as a bicycle, and the tent can be unloaded from the bike trailer (3) and used. Additionally, the bicycle and the bike trailer (3) can be separated. In this case, since the bike trailer (3) can tilt to one side, the wheel assembly (400) can be easily removed, and then the bike trailer (3) can be stably and flatly placed on the ground. Such a bike trailer 3 can also be used as supports or tables for leisure activities.

In addition, according to an embodiment of the present invention, it is possible to provide a bike tent with a wheel assembly that can be attached to and detached from a tent frame so that the tent itself can be connected to a transportation means such as a bicycle or a cart to be pulled around.

In addition, according to an embodiment of the present invention, since the wheel assembly and a connecting member for connecting the bike tent to the bicycle are attachable to and detachable from the tent frame, the bike tent itself can be moved by the bicycle and then installed without any additional means, thereby reducing weight and making it convenient to use.

In addition, according to an embodiment of the present invention, the bike trailer and bike tent are convenient to store, and when the tent is connected to the bicycle and covered with a waterproof cover and moved, the tent can be prevented from getting wet in the event of rain.

The effects of the present invention are not limited to the effects described above, and should be understood to include all effects that can be inferred from the detailed description of the present invention or the composition of the invention described in the claims.

### DESCRIPTION OF DRAWINGS

FIG. 1 shows a connection state between a bike trailer and a bicycle according to an embodiment of the present invention.

FIG. 2 shows a disassembled state of the bike trailer shown in FIG. 1.

FIG. 3 shows a wheel assembly coupled to a wheel coupling part.

FIG. 4 is a view showing the wheel coupling part of a support frame of a trailer body and the wheel assembly when seen from the bicycle side.

FIG. 5 is a view showing the wheel coupling part of the support frame of the trailer body and the wheel assembly when seen from above.

FIG. 6 shows a state in which a wheel coupling boss of the wheel assembly is disposed for coupling to a pipe part to which a hooking member is coupled.

FIG. 7 shows a process of inserting the wheel coupling boss of the wheel assembly into the pipe part.

FIG. 8 shows a state in which an external force is removed from a nut and an end portion of the hooking member is inserted into a hooking groove of the wheel coupling boss.

FIG. 9 shows an example of a folding tent (100) shown in FIGS. 1 and 2.

FIG. 10 shows an example of a tent frame of the folding tent shown in FIG. 9.

FIG. 11 shows a state in which a bike tent is unfolded according to the embodiment of the present invention.

FIG. 12 shows a state in which a wheel mounting unit and the wheel assembly are installed in a folding mode of the folding tent of FIG. 11.

FIG. 13 shows a state in which the wheel mounting unit and the wheel assembly are removed from the bike tent shown in FIG. 12.

FIG. 14 is a view showing an example of the connecting member of the bike tent.

FIG. 15 is a view showing an example of a handle member.

FIG. 16 is a view showing an example of a coupling member.

FIG. 17 is a view showing a state in which the handle member and the connecting member are coupled to each other.

FIG. 18 is a view showing a state in which a coupling member and the connecting member are coupled to each other.

FIG. 19 is a view showing an example of a trailer cover that covers the trailer body and has a storage space.

FIG. 20 is a view showing a state in which a zipper of trailer cover is closed.

FIG. 21 is a view showing another embodiment of the trailer cover.

FIG. 22 is a view showing another example of a tent.

FIG. 23 is a view showing a state in which a first sheet and a second sheet are separated.

FIG. 24 is a view showing a state in which the first sheet and the second sheet are coupled to each other.

### MODES OF THE INVENTION

The present invention may be modified in various ways and may take many forms, and specific embodiments are shown in the drawings and described in detail in the specification. However, the specific embodiments are not intended to limit the present invention, and should be understood to include all modifications, equivalents, or substitutes included in the spirit and technical scope of the present invention. In describing each drawing, similar reference numerals are used for similar components.

Unless otherwise defined, all terms used herein, including technical or scientific terms, have the same meaning as commonly understood by a person of ordinary skill in the art to which the present invention belongs. Terms defined in commonly used dictionaries should be interpreted as having meanings consistent with their meanings in the context of the relevant art, and will not be interpreted in an idealized or overly formal sense, unless expressly defined otherwise in this application.

Hereinafter, with reference to the attached drawings, an exemplary embodiment of the present invention will be described in more detail.

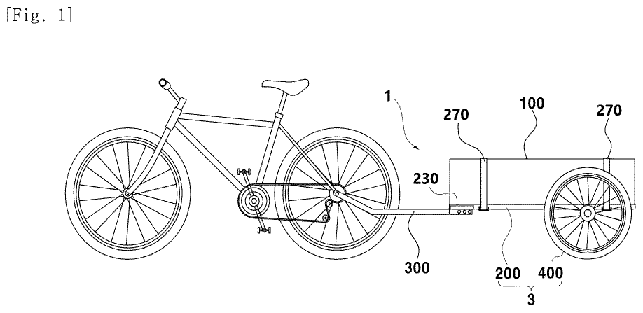

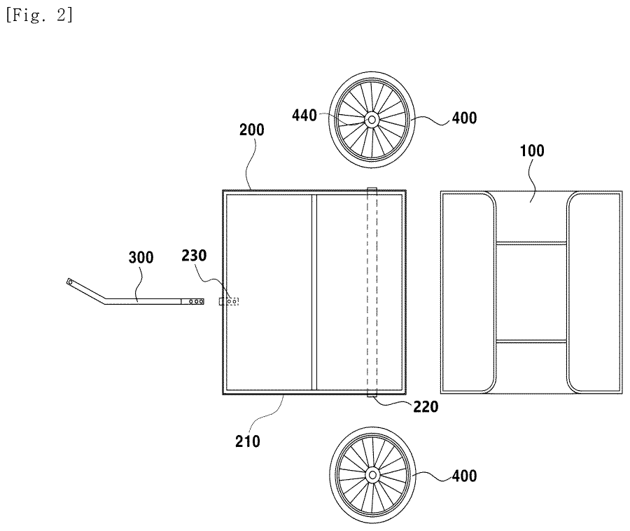

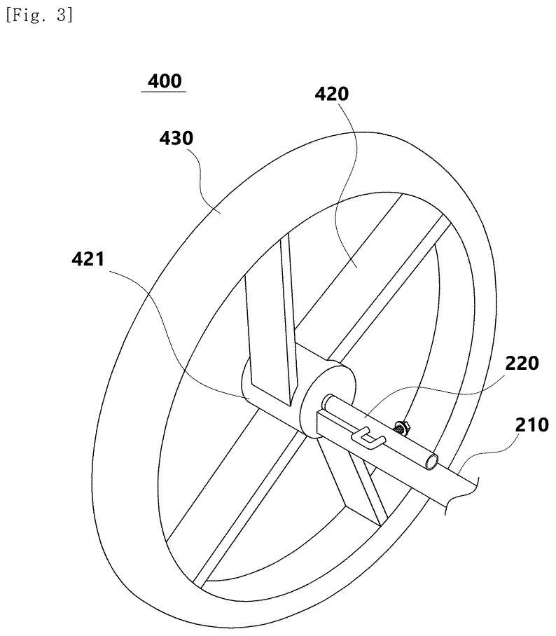

FIG. 1 shows a connection state between a bike trailer 3 and a bicycle according to an embodiment of the present invention. FIG. 2 shows a disassembled state of the bike trailer 3 shown in FIG. 1. FIG. 3 shows a wheel assembly connected to a wheel coupling part.

Referring to FIGS. 1 to 3, the bike trailer 3 according to the embodiment of the present invention may load leisure items and be moved by a transportation means. The bike trailer 3 may include a trailer body 200 and a wheel assembly 400. The trailer body 200 may include a support frame 210 that supports the leisure items, a wheel coupling part 220 provided on each of the left and right sides of the support frame 210, and a transportation coupling part 230 formed on the support frame 210 to be coupled to the rear side of a transportation means by a connecting member 300. The wheel assembly 400 may include a journal 410 having a bearing, a wheel 420 that is supported by the journal 410 to rotate and has a wheel hub which accommodates the journal 410, a tire 430 coupled to the wheel 420, and a wheel coupling boss 440 that protrudes left and right from the journal 410 and is detachably coupled to the wheel coupling part 220.

The transportation means for transporting the bike trailer 3 may be a bicycle, a cart, a motorcycle, an automobile, and the like. The leisure items that can be loaded into the bike trailer 3 include camping equipment, fishing gear, water sports equipment, and sports equipment. In particular, the camping equipment includes tents, cooking utensils, sleeping bags, and the like.

The bike trailer 3 is convenient to use because the wheel assembly 400 may be easily attached to and detached from the trailer body 200, and the wheel assembly 400 and the trailer body 200 may be separated for storage and management.

Hereinafter, a bike tent 1 will be described as another embodiment of the present invention in which a folding tent 100 is loaded in the bike trailer 3, and the bike trailer 3 described above is described in more detail during the description of the bike tent 1.

Referring to FIG. 1, the bike tent 1 may include the folding tent 100, the bike trailer 3, and the connecting member 300.

The folding tent 100 may be switched between a folding mode in which the frame is folded, and a camping mode in which the frame is unfolded. The folding tent 100 may be loaded into the bike trailer 3 in the folding mode. The folding tent 100 will be described in more detail below.

The connecting member 300 may connect the bike trailer 3 and the transportation means, that is, a bicycle in the embodiment. Easily detachable members such as brackets, bolts, pins, or the like may be used as the connecting member 300 for connecting the bike tent 1 to the rear side of the bicycle.

After the folding tent 100 is loaded into the bike trailer 3, the folding tent 100 is fixed to the bike trailer 3 using a tent fixing member 270, thereby preventing the folding tent 100 from being detached from the bike trailer 3 while moving using the bicycle. To prevent the folding tent 100 from getting wet in the event of rain, the folding tent 100 may be covered with a waterproof tent cover and then loaded into the bike trailer 3.

Referring to FIG. 2, the bike tent 1 may be disassembled into the folding tent 100, the bike trailer 3, the connecting member 300, and the wheel assembly 400. The folding tent 100 may be folded into a quadrangular shape when seen from above, and may be configured in a size and shape that can be loaded into the bike trailer 3 when folded.

In the case of transporting the folding tent 100 by loading it into a car instead of using a bicycle to move the bike tent 1, as shown in FIG. 2, the bike tent 1 may be disassembled into the folding tent 100 and other components 200, 300 and 400, so that only the folding tent 100 may be loaded into a trunk of the car, and the other components 200, 300 and 400 may be stored at home.

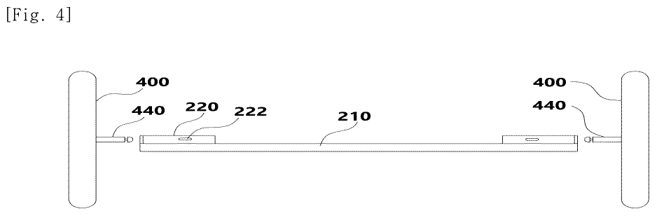

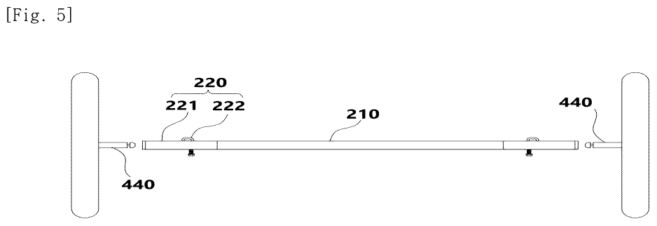

FIG. 4 is a view showing the wheel coupling part 220 of the support frame 210 of the trailer body 200 and the wheel assembly 400 as seen from the bicycle side. FIG. 5 is a view showing the wheel coupling part 220 of the support frame 210 of the trailer body 200 and wheel assembly 400 as seen from above.

Referring to FIGS. 1 to 5, the bike trailer 3 may include the trailer body 200 and the wheel assembly 400.

The trailer body 200 may include the support frame 210, the wheel coupling part 220, and the transportation coupling part 230. The support frame 210 may include front and rear frames and left and right frames to have an approximately quadrangular shape. The support frame 210 may support the folding tent 100. The wheel coupling part 220 may be provided on each of the left and right sides of the support frame 210. The wheel coupling part 220 may be coupled by a method such as welding to each side of one of the left and right frames of the support frame 210.

The transportation coupling part 230 may be provided approximately in the center of the left-right frame located at the front among the left and right frames so that the connecting member 300 coupled to the rear side of the bicycle can be detachably and rotatably coupled. The connecting member 300 shown in FIGS. 1 and 2 may be connected to the transportation coupling part 230 of the support frame 210 as shown in FIG. 1.

The wheel assembly 400 may include the journal 410, the wheel 420, the tire 430, and the wheel coupling boss 440. The journal 410 may include a bearing, an inner cylindrical part, and an outer cylindrical part. The bearing may be installed between the inner cylindrical part and the outer cylindrical part. Thus, while the inner cylindrical part is fixed, the outer cylindrical part may be rotated by the bearing. The inner cylindrical part may act as a shaft. The wheel 420 may include support chassis and a circular frame as a support body that supports a load of the wheel assembly 400. The wheel hub 421 may be formed at the center of the wheel 420. The journal 410 may be accommodated in the wheel hub 421. The outer cylindrical part of the journal 410 may be coupled to an inner portion of the wheel hub 421. Thus, the wheel 420 may rotate while supported by the inner cylindrical part, that is, the shaft. The tire 430 may be coupled to the circular frame of the wheel 420. The wheel coupling boss 440 may protrude left and right from the journal 410 and be detachably coupled to the wheel coupling part 220. For example, the wheel coupling boss 440 may be integrally formed with the inner cylindrical part of the journal 410, welded thereto, or joined by a fastening member. Therefore, since the wheel coupling boss 440 is coupled to the wheel coupling part 220 of the trailer body 200, and the wheel 420 and the wheel coupling boss 440 are connected by the bearing, when the wheel assembly 400 rotates, the wheel coupling boss 440 may remain coupled to the wheel coupling part 220 without rotating.

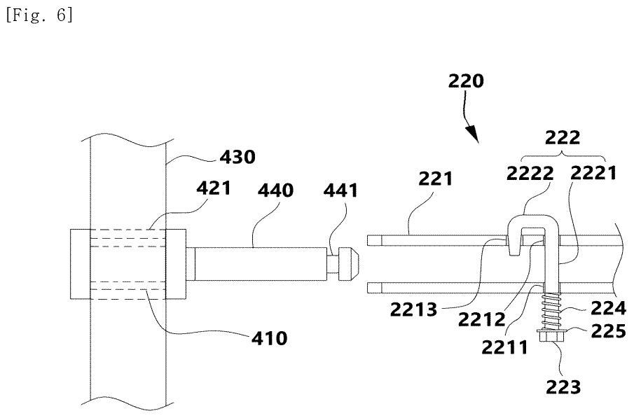

FIG. 6 shows a state in which the wheel coupling boss 440 of the wheel assembly 400 is disposed for coupling to the pipe part 221 to which the hooking member 222 is coupled.

Referring to FIG. 6, the wheel coupling part 220 may include the pipe part 221, the hooking member 222, a nut 223, a coil spring 224, and a washer 225.

The pipe part 221 may have a hollow cylindrical shape. The pipe part 221 may be coupled to the left-right frame by welding or other methods to extend in left and right directions. The pipe part 221 may be coupled to an upper surface of the left-right frame on both left and right sides of the left-right frame. In the pipe part 221, a first hole 2211 and a second hole 2212 facing the first hole 2211 may be formed in a front and rear directions, and a third hole 2213 may be formed next to the second hole 2212 in the left and right directions.

The hooking member 222 may have a U-shape or a ? shape with one end portion being short. The hooking member 222 may include a straight portion 2221 inserted to penetrate the first hole 2211 and the second hole 2212, and a head portion 2222 that is bent in the left and right directions from one end of the straight portion 2221 protruding through the second hole 2212 and then bent again in the front and rear directions and inserted into the third hole 2213. The nut 223 may be screwed onto a screw thread formed on the other end of the straight portion 2221 protruding into the first hole 2211. The coil spring 224 may be provided between the nut 223 and the first hole 2211 to be penetrated by the straight portion 2221. The washer 225 may be interposed between the coil spring 224 and the nut 223. The wheel coupling part 220 may be assembled by inserting the other end of the straight portion 2221 of the hooking member 222 into the second hole 2212 and coupling the other end so that it protrudes through the first hole 2211, installing the coil spring 224 in the straight portion 2221 protruding through the first hole 2211, arranging the washer 225 on the end side of the coil spring 224, and then fastening the nut 223 to the screw thread of the straight portion 2221. A restoring force of the coil spring 224 acts to push the washer 225, and thus, the head portion 2222 of the hooking member 222 approaches the pipe part 221, and the end portion of the head portion 2222 may be inserted into the third hole 2213.

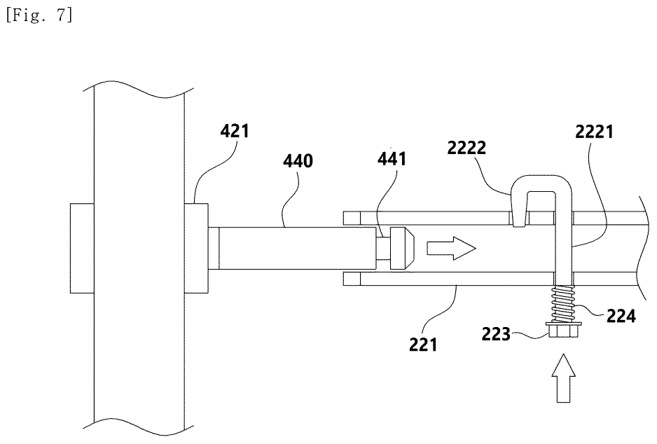

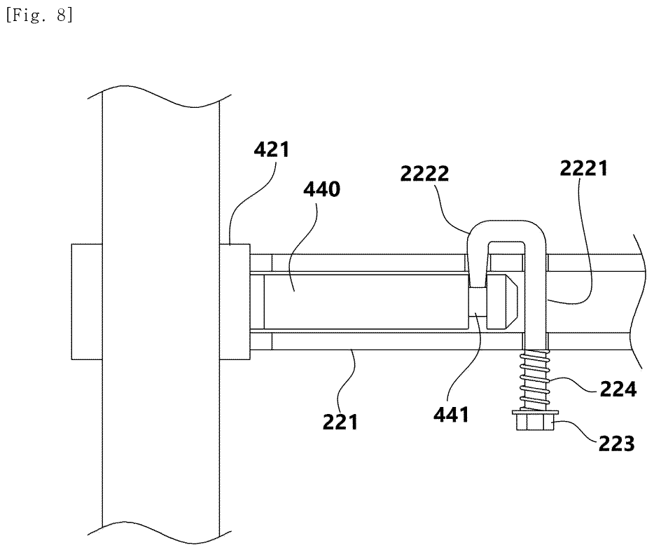

FIG. 7 shows a process of inserting the wheel coupling boss 440 of the wheel assembly 400 into the pipe part 221. FIG. 8 shows a state in which an external force is removed from the nut 223 and the end portion of the hooking member 222 is inserted into the hooking groove 441 of the wheel coupling boss 440.

Referring to FIGS. 7 and 8, the hooking groove 441 that has a depth designed to allow the end portion of the head portion 2222 of the hooking member inserted into the pipe part 221 to be inserted therein and extends in a circumferential direction is formed in a side surface of the wheel coupling boss 440 and, the end portion of the wheel coupling boss 440 may be formed to be tapered so as to have a reduced diameter.

In a state in which an external force is applied to the nut 223 so that the coil spring 224 is compressed and thus the end portion of the head portion 2222 of the hooking member 222 partially protrudes from the second hole 2212, the wheel coupling boss 440 is inserted into the pipe part 221, then the external force is removed, and the coil spring 224 is restored so that the end portion of the head portion 2222 of the hooking member 222 is inserted into the hooking groove 441, whereby the wheel assembly 400 can be mounted in the trailer body 200. In addition, as an external force is applied to the nut 223, and the coil spring 224 is compressed, the end portion of the head portion 2222 of the hooking member 222 is separated from the hooking groove 441, and the wheel coupling boss 440 is pulled out of the pipe part 221, whereby the wheel assembly 400 may be detached from the trailer body 200.

In this way, the wheel assembly 400 can be easily attached to and detached from the trailer body 200, making it convenient to use. After the wheel assembly 400 is attached to the bike trailer 3, the bike trailer 3 can be moved to a camping site by connecting it to a transportation means such as a bicycle, and the tent can be unloaded from the bike trailer 3 and used. The bicycle and the bike trailer 3 may be separated. In this case, since the bike trailer 3 may tilt to one side, the wheel assembly 400 may be easily detached, and then the bike trailer 3 may be stably and flatly placed on the ground. The bike trailer 3 can also be used as a support or table for leisure activities.

As described above, the bike tent 1 may be used for transportation by loading a folding tent 100. The folding tent 100 is described as follows as an example.

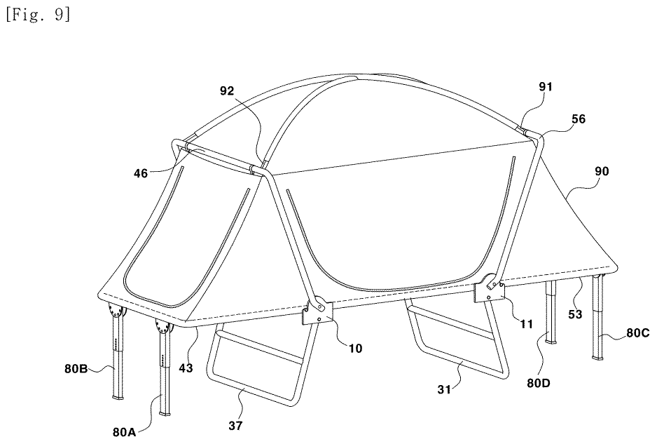

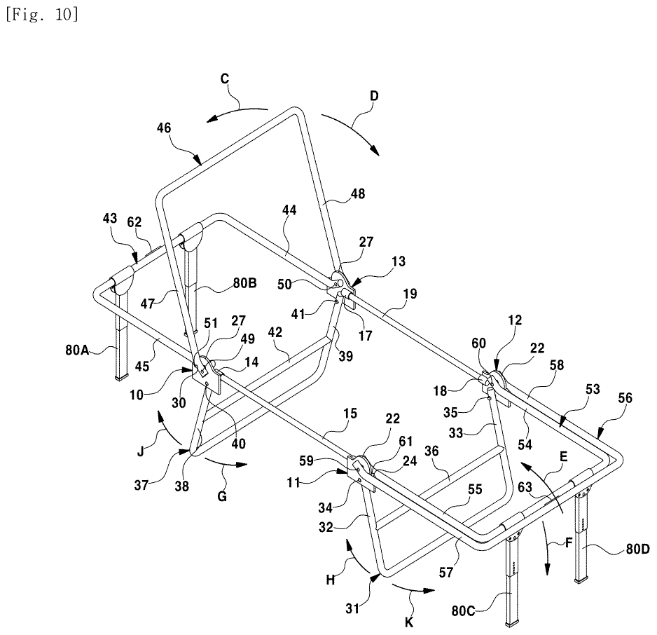

FIG. 9 shows an example of the folding tent 100 shown in FIGS. 1 and 2. FIG. 10 shows an example of the tent frame of the folding tent shown in FIG. 9.

Referring to FIGS. 9 and 10, the tent 100 may include a tent cloth 90, a pole 92, and a frame. The frame may include tent support members 46 and 56, outer support members 43 and 53, U-shaped legs 31 and 37, straight legs 80A to 80D, and hinge members 10, 11, 12 and 13.

The tent cloth 90 may be configured to be able to open or close the inside and outside of the tent 100 using a coupling member such as a zipper on a side or front surface. The tent cloth 90 may be fixed to the tent frame by a fixing member.

An upper end portion of the tent cloth 90 may be formed in a dome shape. The upper end portion of the tent cloth 90 may have a pole receiving passage through which a pole 91 passes and is received. Two poles 91 intersect in an X shape, and each of end portions of the poles 91 may be fixed by a stopper located near an end portion of each of the tent support member 46 and 56.

The tent 100 may be supported on the ground by the U-shaped legs 31 and 37 and the straight legs 80A to 80D. The U-shaped legs 31 and 37 may be folded toward a central portion of a lower end of the tent 100.

The left-side tent support member 46 and outer support member 43 may be folded by being rotated toward a center portion of an upper end of the tent 100 using the hinge members 10 and 13 as pivot axes. The right-side tent support member 56 and outer support member 53 may be folded by being rotated toward the center portion of the upper end of the tent 100 using the hinge members 11 and 12 as pivot axes. Before the tent support members 46 and 56 and the outer support members 43 and 53 are folded, the poles 91 and 92 may be removed from the pole receiving passage.

When the tent is folded, the left-side straight leg 80A and 80B may be rotated inward of the left-side outer support member 43, and the right-side straight leg 80C and 80D may be rotated inward of the right-side outer support member 53.

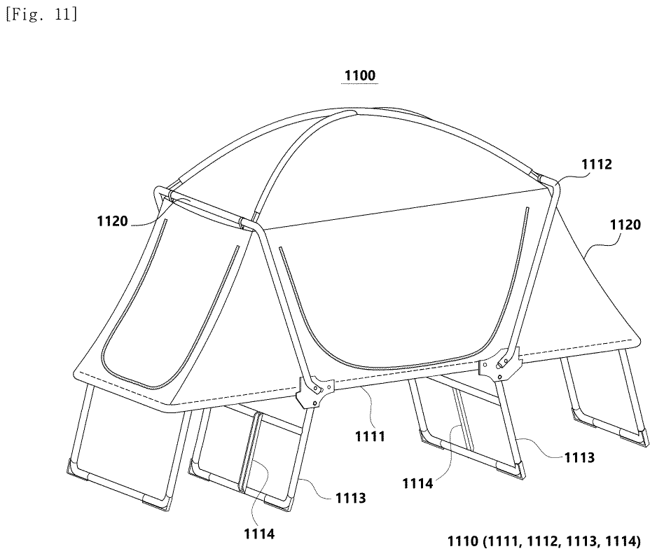

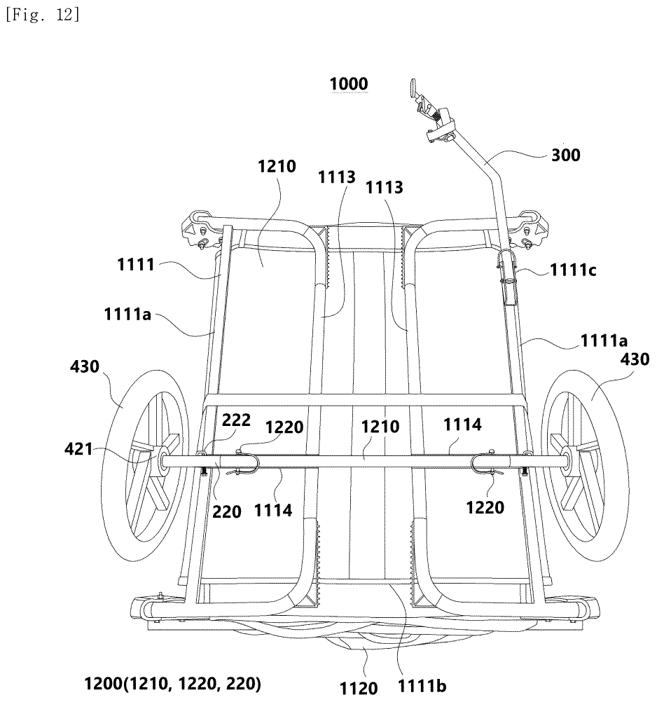

FIG. 11 shows a state in which the bike tent 1000 according to an embodiment of the present invention is unfolded. FIG. 12 shows a state in which the wheel mounting unit and the wheel assembly are installed in a folding mode of the folding tent of FIG. 11. Referring to FIGS. 11 and 12, the bike tent 1000 includes a folding tent 1100, a connecting member 300, a wheel mounting unit 1200, and a wheel assembly 400.

The folding tent 1100 of the embodiment is a folding tent 1100 that can be switched between a folding mode in which it is folded and a camping mode in which it is unfolded, and may include a foldable tent frame 1110 and a tent cloth that is connected to at least a part of the tent frame 1110 and supported by the tent frame 1110. The folding tent 1100 shown in FIG. 11 is similar to the folding tent 100 described in FIGS. 9 and 10, but differs in that the wheel assembly 400 is detachably attached to the folding tent itself and a structure of the tent frame 1110 is changed to achieve this feature. This will be described in more detail below.

The connecting member 300 may connect a transportation means such as a bicycle and the tent frame 1110.

The wheel mounting unit 1200 may be coupled to the lower side of the tent frame 1110.

The wheel assembly 400 may include a journal 410 having a bearing, a wheel hub 421 that accommodates the journal 410, a wheel 420 that is supported by the journal 410 to rotate, a tire 430 coupled to the wheel, and a wheel coupling boss 440 that protrudes left and right from the journal 410 and is detachably coupled to the wheel mounting unit 1200. The wheel assembly 400 may be connected to each of the left and right sides of the wheel mounting unit 1200. As an example of a configuration of the wheel assembly, the structure of the wheel assembly 400 of the bike trailer described above may be adopted.

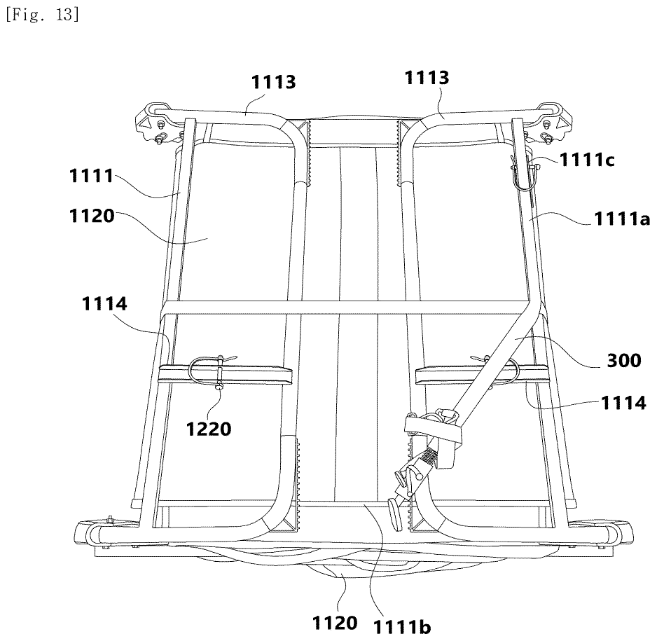

FIG. 13 shows a state in which the wheel mounting unit 1200 and the wheel assembly 400 are separated from the bike tent 1000 shown in FIG. 12.

Referring to FIG. 13, the tent frame 1110 may include a main frame 1111 connected to a bottom of the tent cloth 1120, a pair of upper frames 1112 that are rotatably installed on the main frame 1111 and unfold the tent cloth 1120 upward to support it, a pair of lower frames 1113 that are rotatably installed on the main frame 1111 and unfolded to support the main frame 1111, and a slot frame 1114. The slot frame 1114 has a “U” shaped cross section and is coupled to each of the lower frames 1113 to extend in the left and right directions. In the embodiment, the slot frame 1114 is welded to the main frame 1111. The wheel mounting unit 1200 may be detachably coupled to the slot frame 1114.

Referring again to FIG. 12, the wheel mounting unit 1200 may include a shaft bar 1210 that is inserted into the pair of slot frames 1114 in the folding mode and extends in the left and right directions, a fastening member 1220 that penetrates the shaft bar 1210 and the slot frame 1114 in the front and rear directions to couple them, and a wheel coupling part 220. In a state in which the pair of lower frames 1113 are folded on the main frame 1111, the slot frames 1114 respectively provided on the lower frames 1113 may be arranged in a straight line in the left and right directions. A cross-section of the slot frame 1114 may have a trench structure or slot structure having a “U” shape. The shaft bar 1210 may be a strong metal bar that supports the folding tent 1100 and the wheel assembly 400. The shaft bar 1210 may be a quadrangular bar or a quadrangular cross-section pipe that is inserted into the slot frame 1114. The shaft bar 1210 may be inserted into the slot frame 1114 as shown in FIG. 12 and fixed to the slot frame 1114 by the fastening member 1220 such as a pin. The wheel coupling part 220 may be coupled to left and right edges of the shaft bar 1210. The wheel coupling boss 440 of the wheel assembly may be detachably coupled to the wheel coupling part 220.

The wheel coupling part 220 may include the pipe part 221, the hooking member 222, the nut 223, the coil spring 224, and the washer 225. The pipe part may be welded to extend in the left and right directions to both edges of the shaft bar 1210. In the pipe part, a first hole and a second hole facing the first hole may formed in the front and rear directions, and a third hole may be formed next to the second hole in the left and right directions. The hooking member may be a U-shaped member with one end portion being short, and may include a straight portion inserted to penetrate the first hole and the second hole, and a head portion bent in the left and right directions from one end of the straight portion protruding through the second hole and then bent again in the front and rear directions to be inserted into the third hole. The nut may be coupled to a screw thread formed on the other end of the straight portion protruding through the first hole. The coil spring may be provided between the nut and the first hole to be penetrated by the straight portion. The washer may be interposed between the coil spring and the nut. As an example, the wheel coupling part 220 may adopt the configuration of the wheel coupling part 220 described in the bike trailer shown in FIGS. 3 to 8.

The wheel assembly 400 and the wheel mounting unit 1200 may be separated, and the wheel mounting unit 1200 may be detached from the slot frame 1114 of the folding tent 1100. In addition, the folding tent 1100 may be used in the folding mode and the camping mode. Therefore, the folding tent 110 may be moved by disassembling and reducing a volume thereof, and is easy to store and handle. At a camp site, the wheel assembly 400 and wheel mounting unit 1200 may be separated and then the lower frame 1113 and upper frame 1112 may be unfolded for use.

The main frame 1111 includes front and rear frames 1111a and left and right frames 1111b that are coupled to each other to have a quadrangular shape, and the pair of lower frames 1113 may be respectively coupled to the front and rear frames 1111a to be rotatable about an axis in the front-rear directions. One of the front and rear frames is provided with a connecting bracket 1111c, and one end of the connecting member 300 is rotatably connected to the connecting bracket 1111c to be rotatable about an axis in the left and right directions. The other end of the connecting member 300 is bent toward a center line in the left and right directions and may be connected to a transportation means such as a bicycle. Thus, the bike tent 1000 may be connected to the bicycle and transported by the wheel assembly 400 rolling on the ground.

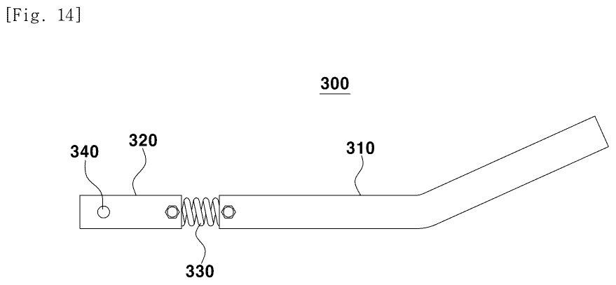

FIG. 14 is a view showing an example of the connecting member 300 of the bike tent 1000.

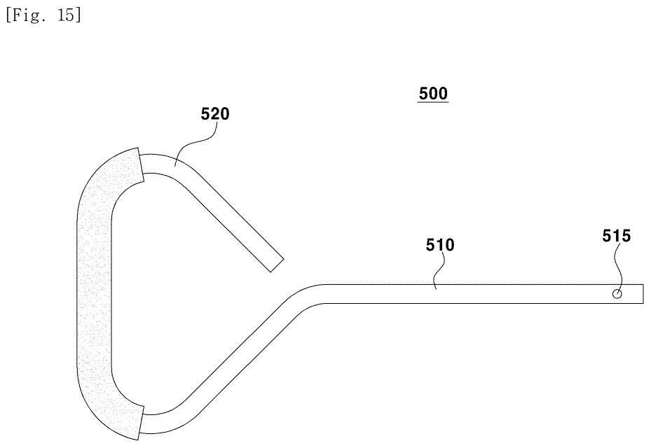

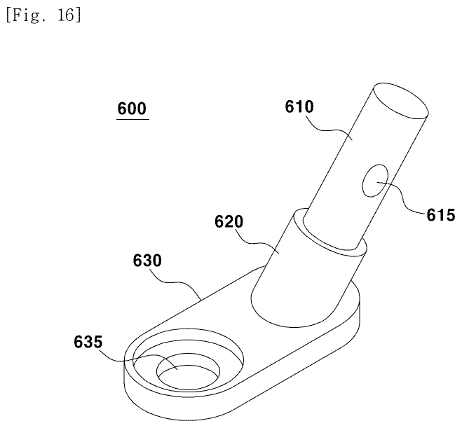

Referring to FIG. 14, the connecting member 300 may include a first connecting part 310, a second connecting part 320, and a spring part 330. The connecting member 300 may be detachably coupled to a handle member 500 (refer to FIG. 15) for a user to hold and move the bike trailer or a coupling member 600 (refer to FIG. 16) for connecting to the rear side of a transportation means.

The first connecting part 310 may be coupled to the connecting bracket 1111c of the trailer body. A first fixing hole (not shown) for coupling to the connecting bracket 1111c may be provided in an end portion of the first connecting part 310 located on the side opposite to the spring part 330. A second fixing hole (not shown) for rotation of the connecting member 300 may be provided near the first fixing hole (not shown). The first and second fixing holes of the first connecting part 310 and the connecting bracket 1111c may be coupled by a fastening member such as a fixing pin or bolt.

The first connecting part 310 may has a bent portion between both ends. In the case in which the connecting bracket 1111c of the trailer body is disposed near a side surface of the trailer body, since the first connecting part 310 has the bent portion, a movement direction of the transportation means and a movement direction of the trailer body may be arranged on the same axis.

The second connecting part 320 has a pipe shape and may be coupled to the handle member 500 or the coupling member 600. One end of the handle member 500 or the coupling member 600 may be inserted into a pipe shape of the second connecting part 320.

The second connecting part 320 may have a through hole 340. The second connecting part 320 may be detachably coupled to the handle member 500 or the coupling member 600 using a fastening means such as a bolt or a fixing pin 351.

The spring part 330 may be coupled to one end of the first connecting part 310 and one end of the second connecting part 320. The spring part 330 and the first connecting part 310 or the spring part 330 and the second connecting part 320 may be coupled by a fastening means such as a bolt or pin.

The spring part 330 may elastically couple the first connecting part 310 and the second connecting part 320 between the first connecting part 310 and the second connecting part 320. The spring part 330 has a function of buffering a displacement that occurs between the second connecting part 320 coupled to the transportation means and the first connecting part 310 coupled to the trailer body.

FIG. 15 is a view showing an example of the handle member 500.

Referring to FIG. 15, the handle member 500 may include a base portion 510 and a handle portion 520. A user may easily move the trailer to a desired location by coupling the handle member 500 to the connecting member 300.

The base portion 510 may be detachably coupled to the second connecting part 320 of the connecting member 300. The base portion 510 may have one or more through holes 515. The handle member 500 and the connecting member 300 may be coupled to each other by coupling a fixing pin 351 to pass through the through hole 515 of the base portion 510 and the through hole 340 of the connecting member 300.

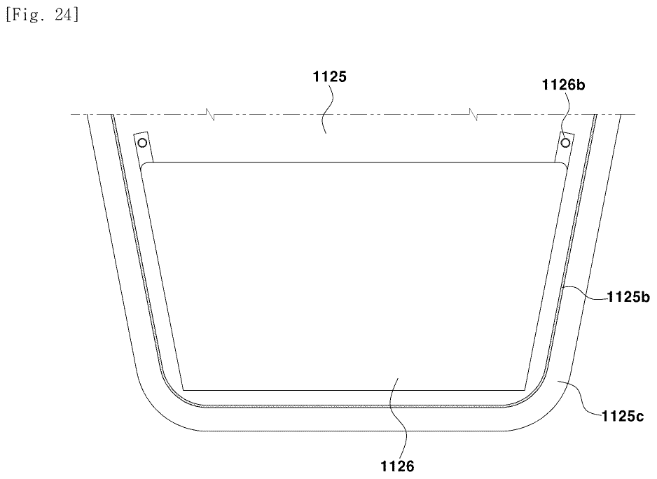

The handle portion 520 extends from the base portion 510 and may be configured in a shape that can be held by the user. A portion of the handle portion 520 may be covered with an elastic material such as a sponge. The handle portion 520 may have a triangular shape, for example, as shown in FIG. 24, but the technical idea of the present invention is not limited to this shape.

FIG. 16 is a view showing an example of the coupling member 600.

Referring to FIG. 16, the coupling member 600 may have an insertion part 610, an intermediate part 620, and a coupling part 630.

The insertion part 610 may have a cylindrical shape that is inserted into the pipe shape of the second connecting part 320 of the connecting member 300. The insertion part 610 may be configured to have a diameter smaller than an inner diameter of the second connecting part 320. The insertion part 610 may have a through hole 615 through which the fixing pin 351 passes.

The intermediate part 620 may extend from one end of the insertion part 610. The intermediate part 620 may have a dimension larger than an inner diameter of the pipe shape of the first connecting part 310 of the connecting member 300.

The coupling part 630 may have a first portion that is coupled to one end of the intermediate part 620 and a second portion in which a fixing hole 635 is formed. The coupling part 630 may be coupled to the rear side of the transportation means using the fixing hole 635 and a fastening means (bolt, pin, or the like).

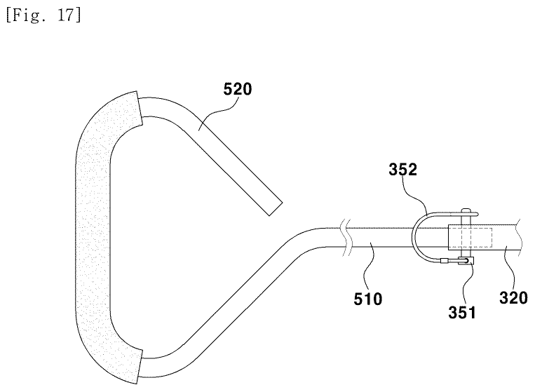

FIG. 17 is a view showing a state in which the handle member 500 and the connecting member 300 are coupled to each other.

Referring to FIG. 17, the handle member 500 and the connecting member 300 may be coupled to each other using the fixing pin 351. Both ends of the fixing pin 351 may be fixed using a fixing clamp 352.

When the handle member 500 and the connecting member 300 are coupled to each other, the through hole 515 of the base portion 510 and the through hole 340 of the second connecting part 320 may be disposed on the same axis. The fixing pin 351 may pass through the through hole 515 of the base portion 510 and the through hole 340 of the second connecting part 320. The fixing pin 351 may be fixed using the fixing clamp 352.

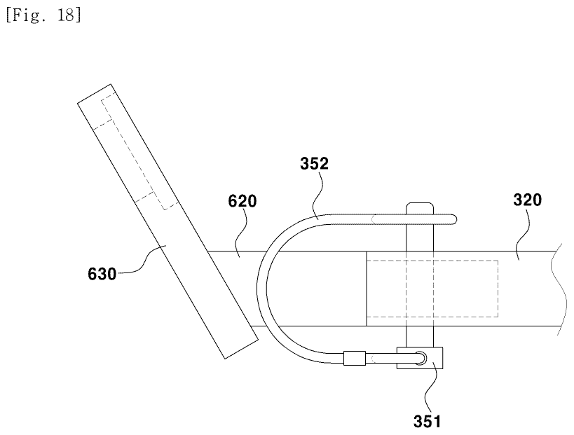

FIG. 18 is a view showing a state in which the coupling member 600 and the connecting member 300 are coupled to each other.

Referring to FIG. 18, the coupling member 600 and the connecting member 300 may be coupled using the fixing pin 351. Both ends of the fixing pin 351 may be fixed using the fixing clamp 352.

When the coupling member 600 and the connecting member 300 are coupled, the through hole 615 of the insertion part 610 and the through hole 340 of the second connecting part 320 may be disposed on the same axis. The fixing pin 351 may pass through the through hole 615 of the insertion part 610 and the through hole 340 of the second connecting part 320. The fixing pin 351 may be fixed using the fixing clamp 352.

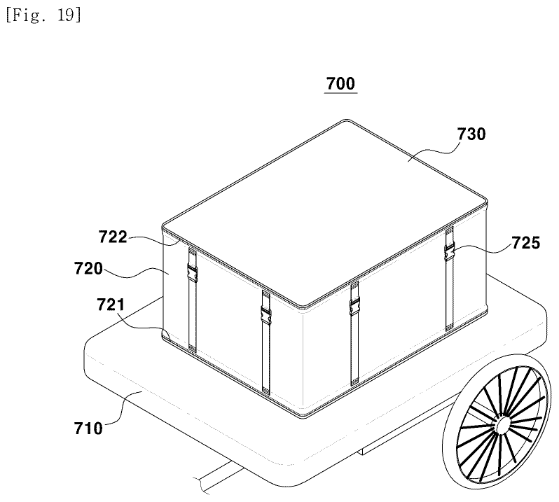

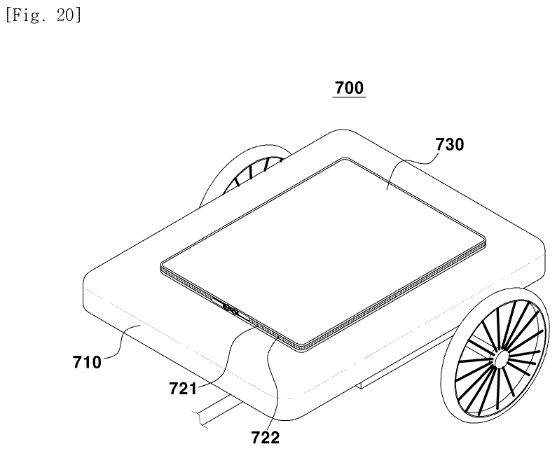

FIG. 19 is a view showing an example of a trailer cover 700 that covers the trailer body and has a storage space. FIG. 20 is a view showing a state in which a zipper of the trailer cover 700 is closed.

Referring to FIG. 19, the trailer cover 700 may include a main cover 710, a side cover 720, and a top cover 730.

The main cover 710 may be configured to cover the entire upper surface of the trailer body 200. A fastening means may be provided at an edge of the main cover 710 to maintain a state in which the main cover 710 covers the trailer body 200.

The side cover 720 extends upward from the main cover 710 and may form a storage space. The side cover 720 may form a storage space having various three-dimensional shapes, such as a triangular pillar, a quadrangular pillar, or a pentagonal pillar. Although FIG. 19 shows that the side cover 720 forms a quadrangular pillar, the scope of the present invention is not limited to this example.

The upper cover 730 covers an upper portion of the side cover 720 and the storage space formed by the side cover 720, and may seal the storage space. The upper cover 730 may include a fastening means (a zipper, a fastener, or the like, not shown) for sealing or opening the storage space.

The side cover 720 may include first zipper teeth 721 and second zipper teeth 722. The first zipper teeth 721 and the second zipper teeth 722 may be configured to be fastened to each other. The side cover 720 may include a fastening means (a zipper, a fastener, or the like, not shown) for sealing or opening the storage space.

The first zipper teeth 721 may be formed at a coupling portion of the side cover 720 and the main cover 710. The second zipper teeth 722 may be formed at a coupling portion of the side cover 720 and the upper cover 730.

The side cover 720 may include a fastening member 725 for adjusting a height of the storage space. The height of the storage space formed by the side cover 720 may be adjusted by adjusting a length of the fastening member 725.

Referring to FIG. 20, the first zipper teeth 721 and the second zipper teeth 722 may be fastened by a zipper slider. When the zippers 721 and 722 of the trailer cover 700 are fastened, the storage space may be minimized.

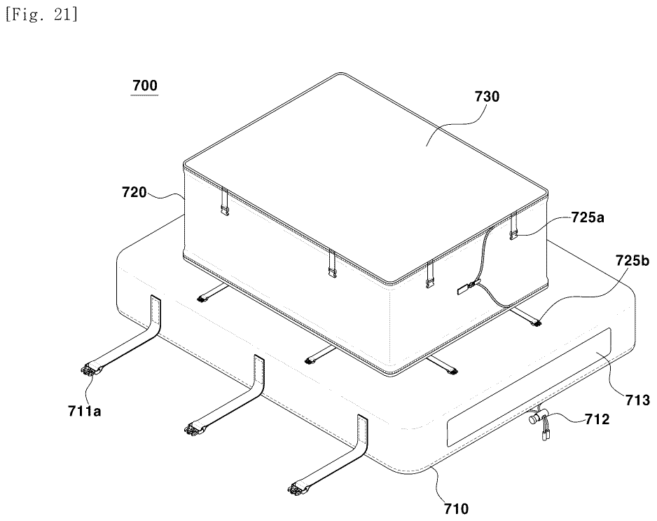

FIG. 21 is a view showing another embodiment of the trailer cover 700.

Referring to FIG. 21, the main cover 710 of the trailer cover 700 may include a first fastening member 711a, a second fastening member 711b (not shown), an adjustment strap 712, and an identification part 713.

The first fastening member 711a may be formed at one end portion of the main cover 710. The second fastening member 711b may be formed at the other end portion of the main cover 710 and may be formed to be coupled to or uncoupled from the first fastening member 711a. Various fastening means such as buckles, clips, Velcro, magnets, and straps may be used as the first fastening member 711a and the second fastening member 711b. One or more first fastening members 711a and second fastening members 711b may be formed. The main cover 710 may be firmly fixed to the trailer using the first fastening member 711a and the second fastening member 711b.

The adjustment strap 712 may be formed at an edge of a lower end portion of the main cover 710. The adjustment strap 712 may be formed to adjust a size of an opening of the lower end portion of the main cover 710. The adjustment strap 712 may be formed of an elastic material.

The identification part 713 may be formed on a portion of the main cover 710 on the side opposite to the transportation means. The identification part 713 may be formed so that the presence of the transportation means is identified by another transportation means following the transportation means. The identification part 713 may include characters, figures, and the like that are easily identifiable with the naked eye. The identification part 713 may include, for example, a retroreflective material that reflects light or a luminous material that emits light at night.

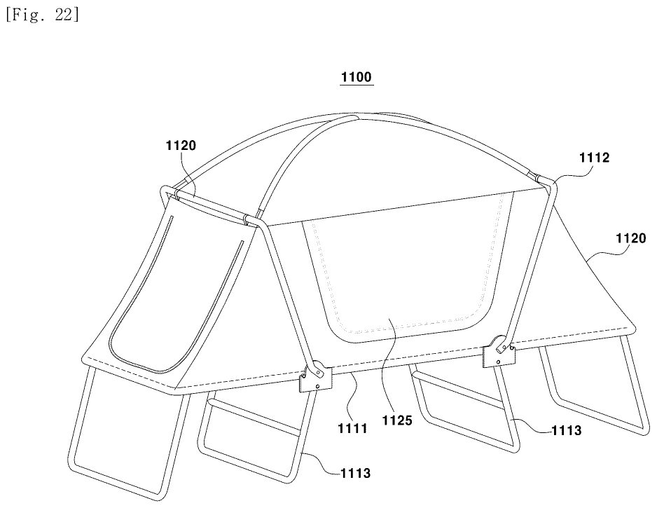

FIG. 22 is a view showing another example of the tent 1100.

The tent 1100 may include a tent cloth 1120 supported by the tent frames 1120, 1111, 1112. The tent cloth 1120 may include an entrance for the user to enter and exit.

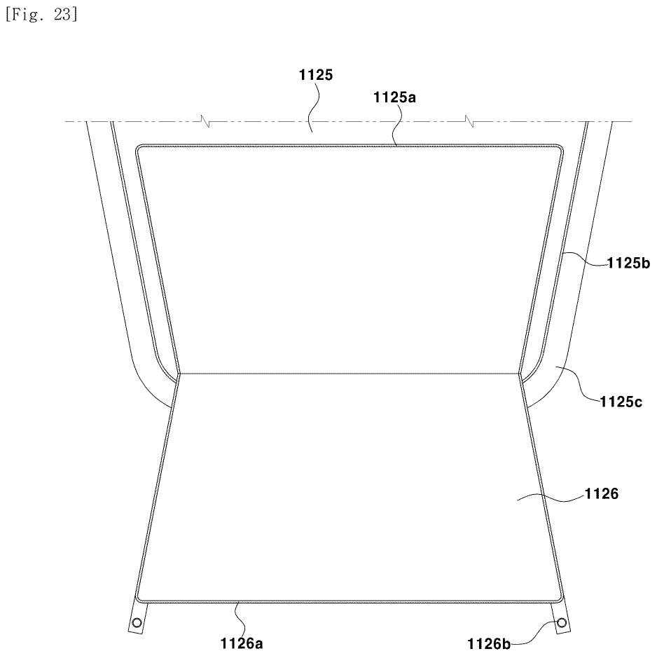

The tent 1100 may include a first sheet 1125 provided in a shape corresponding to the entrance to cover the entrance of the tent cloth 1120. The first sheet 1125 may be coupled to a second sheet 1126 as described below. The detailed configuration of the first sheet 1125 and the second sheet 1126 will be described in detail with reference to FIGS. 23 and 24.

FIG. 23 is a view showing a state in which the first sheet 1125 and the second sheet 1126 are separated. FIG. 24 is a view showing a state in which the first sheet 1125 and the second sheet 1126 are coupled. FIGS. 23 and 24 show the configuration of the first sheet 1125 and the second sheet 1126 when seen from the inside to the outside of the tent 1100 of FIG. 22.

Referring to FIG. 23, the second sheet 1126 may be provided in a shape corresponding to the first sheet 1125. The second sheet 1126 may be formed to have a smaller size than the first sheet 1125. The second sheet 1126 may be coupled to one end portion (a lower end portion of FIG. 32) of the first sheet 1125.

A first coupling member 1125a may be formed at an edge portion of the first sheet 1125, and a second coupling member 1126a may be formed at an edge portion of the second sheet 1126. The first sheet 1125 and the second sheet 1126 may be coupled or decoupled by the first coupling member 1125a and the second coupling member 1126a.

A coupling means such as a zipper or a fastener may be used as the first coupling member 1125a and the second coupling member 1126a. The first coupling member 1125a may be formed to surround three sides of the first sheet. One or more first coupling members 1125a may be formed. The second coupling member 1126a may be formed to surround three sides of the second sheet. One or more second coupling members 1126a may be formed.

The first sheet 1125 may include a third coupling member 1125b. The third coupling member 1125b may be formed further outward than the first coupling member 1125a. The first sheet 1125 and the tent cloth 1120 may be coupled or decoupled by the third coupling member 1125b and the fourth coupling member (not shown) formed at a corresponding position of the tent cloth 1120.

The first sheet 1125 may include an extension sheet 1125c. The extension sheet 1125c may extend further outward than the third coupling member 1125b. The extension sheet 1125c may prevent liquid from entering from outside the tent through the third coupling member 1125b.

The second sheet 1126 may include a fixing hole 1126b for fixing a pole. By separating the second sheet 1126 from the first sheet 1125 and fixing a pole to the fixing hole 1126b of the second sheet 1126, shade can be provided at the tent entrance.

The above description of the present invention is for illustrative purposes only, and a person having ordinary skill in the art to which the present invention pertains will understand that the present invention can be easily modified into other specific forms without changing the technical idea or essential characteristics of the present invention. Therefore, it should be understood that the embodiments described above are exemplary in all respects and not limiting. For example, each component described as a single entity may be implemented in a distributed manner, and likewise, components described as distributed may be implemented in a combined manner.

The scope of the present invention is indicated by the claims described below, and all changes or modifications derived from the meaning and scope of the claims and their equivalent concepts should be interpreted as being included in the scope of the present invention.

### EXPLANATION OF REFERENCES

1: Bike tent
3: Bike trailer
100: Folding tent
200: Trailer body
210: Support frame
220: Wheel coupling part
221: Pipe part
2211: First hole
2212: Second hole
2213: Third hole
222: Hooking member
2221: Straight portion
2222: Head portion
223: Nut
224: Coil spring
225: Washer
230: Transportation coupling part
300: Connecting member
400: Wheel assembly
410: Journal
420: Wheel
421: Wheel hub
430: Tire
440: Wheel coupling boss
441: Hooking groove
90: Tent cloth
91, 92: Pole
46, 56: Tent support member
43, 53: Outer support member
31, 37: U-shaped leg
80A to 80D: Straight leg
10, 11, 12, 13: Hinge member
1000: Bike tent
1100: Folding tent
1111: Tent frame
1111a: front and rear frames
1111b: left and right frames
1111c: Connecting bracket
1112: Tent frame
1113: Lower frame
1114: Slot frame
1200: Wheel mounting unit
1210: Shaft bar
1220: Fastening member
500: Handle member
600: Coupling member
700: Trailer cover

1. A bike trailer (3) which loads a leisure item and is moved by a transportation means, comprising:
a trailer body (200) including a support frame (210) which supports the leisure item, a wheel coupling part (220) provided on each of left and right sides of the support frame, and a transportation coupling part (230) formed on the support frame to be coupled to a rear side of the transportation means by a connecting member (300); and
a wheel assembly (400) including a journal (410) having a bearing, a wheel (420) which is supported by the journal (410) to rotate and has a wheel hub (421) that accommodates the journal (410), a tire (430) coupled to the wheel (420), and a wheel coupling boss (440) which protrudes in left and right directions from the journal (410) and is detachably coupled to the wheel coupling part (220).

2. The bike trailer of claim 1, wherein the wheel coupling part (220) includes:
a pipe part (221) coupled to the support frame (210) to extend in the left and right directions;
a hooking member (222) which penetrates the pipe part (221); and
a spring (224) which controls the hooking member (222) to switch between a first position and a second position by an external force,
wherein the first position is a position at which the wheel coupling boss (440) and the pipe part (221) are coupled, and
the second position is a position at which the wheel coupling boss (440) and the pipe part (221) are decoupled.

3. The bike trailer of claim 2, wherein, in the pipe part (221), a first hole (2211) and a second hole (2212) facing the first hole are formed in front and rear directions, and a third hole (2213) is formed next to the second hole in the left and right directions,
the hooking member (222) is a U-shaped hooking member (222) with one end short, and includes a straight portion (2221) inserted to penetrate the first hole and the second hole, and a head portion (2222) that is bent in the left and right directions from one end of the straight portion protruding through the second hole, then bent again in the front and rear directions and inserted into the third hole,
the wheel coupling part (220) further includes a nut (223) fastened to a screw thread formed on the other end of the straight portion protruding through the first hole; and a washer (225) interposed between the spring (224) and the nut (223), and
the spring (224) is provided between the nut and the first hole to be penetrated by the straight portion.

4. The bike trailer of claim 3, wherein, in a side surface of the wheel coupling boss (440), a hooking groove that extends in a circumferential direction is formed with a depth designed so that an end portion of the head portion of the hooking member is inserted when the wheel coupling boss (440) is inserted into the pipe part, and the end portion of the wheel coupling boss (440) is tapered so that a diameter thereof is reduced.

5. The bike trailer of claim 4, wherein, in a state in which an external force is applied to the nut and the coil spring is compressed so that the end portion of the head portion of the hooking member partially protrudes through the second hole, the wheel coupling boss (440) is inserted into the pipe part, then the external force is removed, and the coil spring is restored, so that the end portion of the head portion of the hooking member is inserted into the hooking groove (441) whereby the wheel is mounted on the trailer body, and as the coil spring is compressed by applying the external force to the nut, the end portion of the head portion of the hooking member is detached from the hooking groove (441), and the wheel coupling boss (440) is pulled out of the pipe part, whereby the wheel assembly is detached from the trailer body.

6. The bike trailer of claim 1, further comprising a connecting member (300) that is coupled to the transportation coupling part (230) of the trailer body (200),
wherein the connecting member (300) is detachably coupled to a handle member (500) for a user to hold and move the bike trailer or a coupling member (600) for coupling to the rear side of the transportation means.

7. The bike trailer of claim 6, wherein the connecting member (300) includes:
a first connecting part (310) coupled to one end portion of the trailer body;
a second connecting part (320) having a pipe shape and coupled to the handle member (500) or the coupling member (600); and
a spring part (330) coupled to one end of the first connecting part (310) and one end of the second connecting part (320), and elastically coupling the first connecting part (310) and the second connecting part (320) between the first connecting part (310) and the second connecting part (320), and
the first connecting part (310) of the connecting member (300) has a bent portion between both ends.

8. The bike trailer of claim 6, wherein the handle member (500) includes:
a base portion (510) which is detachably coupled to the second connecting part (320) of the connecting member (300) and has one or more through holes (515); and
a handle portion (520) which extends from the base portion (510) and is configured in a shape that allows the user to grasp.

9. The bike trailer of claim 6, wherein the coupling member (600) includes:
an insertion part (610) having a cylindrical shape inserted into a pipe shape of the second connecting part (320) of the connecting member (300) and having a through hole (615) through which a fixing pin (351) passes;
an intermediate part (620) which extends from one end of the insertion part (610) and having a dimension larger than an inner diameter of a pipe shape of the first connecting part (310) of the connecting member (300); and
a coupling part (630) having a first portion coupled to one end of the intermediate part (620) and a second portion having a fixing hole (635).

10. The bike trailer of claim 1, further comprising a trailer cover (700),
wherein the trailer cover (700) includes:
a main cover (710) which covers the trailer body (200);
a side cover (720) which extends upward from the main cover (710) and forms a storage space; and
an upper cover (730) which covers an upper portion of the side cover (720) and the storage space formed by the side cover (720) and seals the storage space,
the side cover (720) includes:
first zipper teeth (721) formed at a coupling portion of the side cover (720) and the main cover (710); and
second zipper teeth (722) formed at a coupling portion of the side cover (720) and the upper cover (730) and configured to be fastened to the first zipper teeth (721), and
the main cover (710) includes:
a first fastening member (711a) formed at one end portion of the main cover (710);
a second fastening member (711b) formed at the other end portion of the main cover (710) and configured to be coupled to or uncoupled from the first fastening member;
an adjustment strap (712) formed at an edge of a lower end portion of the main cover (710) and configured to adjust a size of an opening at the lower end portion of the main cover (710); and
an identification part (713) formed at a portion of the main cover (710) on a side opposite to the transportation means and configured to identify presence of the transportation means by another transportation means following the transportation means.

11. A bike tent (1000) comprising:
a foldable tent (1100) which is configured to be switched between a folding mode in which it is folded and a camping mode in which it is unfolded and includes a foldable tent frame (1110) and a tent cloth (1120) coupled to at least a part of the tent frame (1110) and supported by the tent frame (1110);
a connecting member (300) which connects a transportation means and the tent frame (1110);
a wheel mounting unit (1200) coupled to a lower side of the tent frame (1110); and
a wheel assembly (400) detachably coupled to the wheel mounting unit (1200).

12. The bike tent (1000) of claim 11, wherein the wheel assembly (400) includes:
a journal (410) having a bearing;
a wheel which has a wheel hub that accommodates the journal (410), and is supported by the journal (410) to rotate;
a tire (430) coupled to the wheel; and
a wheel coupling boss (440) which protrudes in left and right directions from the journal (410) and is detachably coupled to the wheel mounting unit (1200),
the wheel assembly (400) is coupled to each of left and right sides of the wheel mounting unit (1200),
the tent frame (1110) includes:
a main frame (1111) connected to a bottom of the tent cloth (1120);
a pair of upper frames (1112) which is rotatably installed on the main frame (1111), unfolds the tent cloth upward and supports it;
a pair of lower frames (1113) rotatably installed on the main frame (1111) and unfolded to support the main frame; and
a slot frame (1114) which has a cross-sectional shape that accommodates at least a part of the wheel mounting unit (1200) and is coupled to each of the lower frames (1113) to extend in the left and right directions, and to which the wheel mounting unit (1200) is detachably coupled.

13. The bike tent (1000) of claim 12, wherein the wheel mounting unit (1200) includes:
a shaft bar (1210) which is inserted into a pair of slot frames (1114) in the folding mode and extends in the left and right directions;
a fastening member (1220) which penetrates and connects the shaft bar (1210) and the slot frames (1114) in front and rear directions; and
a wheel coupling part (220) coupled to left and right edges of the shaft bar (1210) and to which the wheel coupling boss of the wheel assembly is detachably coupled.

14. The bike tent (1000) of claim 13, wherein the wheel coupling part (220) includes:
a pipe part (221) which is coupled to both side edges of the shaft bar (1210) to extend in the left and right direction, and in which a first hole and a second hole facing the first hole are formed in the front and rear directions, and a third hole is formed next to the second hole in the left and right directions;
a U-shaped hooking member (222) having one short end, and including a straight portion inserted to penetrate the first hole and the second hole, and a head portion that is bent in the left and right directions from one end of the straight portion protruding through the second hole, then bent again in front and rear directions and inserted into the third hole;
a nut (223) coupled to a screw thread formed on the other end of the straight portion protruding through the first hole;
a coil spring (224) provided between the nut and the first hole to be penetrated by the straight portion; and
a washer (225) interposed between the coil spring and the nut.

15. The bike tent (1000) of claim 11, further comprising:
a first sheet (1125) provided in a shape corresponding to an entrance of the tent cloth (1120) for the user to enter and exit to cover the entrance; and
a second sheet (1126) provided in a shape corresponding to the first sheet and connected to one end portion of the first sheet (1125),
wherein the first sheet (1125) and the second sheet (1126) are coupled or decoupled by a first coupling member (1125a) formed at an edge of the first sheet (1125) and a second coupling member (1126b) formed at an edge of the second sheet (1126).

16. The bike tent 1000 of claim 15, wherein the first sheet (1125) and the tent cloth (1120) are coupled or decoupled by a third coupling member (1125b) formed further outward than the first coupling member (1125a) of the first sheet (1125) and a fourth coupling member formed at a corresponding position of the tent cloth (1120),
the first sheet (1125) includes an extension sheet (1125c) that extends further outward than the third coupling member (1125b) and prevents liquid from entering from outside the tent through the third coupling member (1125b), and
a fixing hole (1126b) which fixes a pole is formed at one end portion of the second sheet (1126).
